(19) United States
(12) Patent Application Publication
(10) Pub. No.: US 2003/0061161 A1
(43) Pub. Date: Mar. 27, 2003

(54) Business method for facilitating offsetting payables against receivables

(76) Inventor: Daniel A. Black, Bemus Point, NY (US)

Correspondence Address: THE BILICKI LAW FIRM, P.C., Furniture Mart Building, Suite 1000, 111 West Second Street, Jamestown, NY, 14701, US

(21) Appl. No.: 10/253,030

(22) Filed: Sep. 23, 2002

Related U.S. Application Data
(60) Provisional application No. 60/324,189, filed on Sep. 21, 2001.

(51) Int. Cl. G06F 17/60

(52) U.S. Cl. 705/40

(57) ABSTRACT

The present invention presents a business method for facilitating a sale of a receivable for the offsetting of payables. The method for the offsetting of payables and sale of receivables is conducted over a computer network preferably composed of a Web server or main computer, a database server, an array of hard disks for storage, and a transaction server. The owner, best offers, and other information about the receivable are open to inspection for registered users in an on-line auction form of the invention. The buyer and seller of the receivable are kept informed of the status of their accounts via e-mail. Alternatively, the business method provides a method of contact for a potential purchaser of the receivable to contact the posting owner of the receivable and negotiate purchase of the receivable.

### PRIORITY

This non-provisional patent application claims priority to provisional application number 60/324,189, filed Sep. 21, 2001.

### FIELD OF INVENTION

The present invention relates generally to the field of on-line sales, and in particular to a method of putting individuals with receivables in contact with individuals with payables via a website for the purpose of offsetting payables against receivables.

### BRIEF DESCRIPTION OF THE DRAWINGS

FIG. 1 is a block diagram illustrating a computer network for a preferred embodiment of the invention.

FIG. 2 is a flowchart illustrating the HTML/website page arrangement for a preferred embodiment of the invention.

FIGS. 3a and 3b show a flowchart of the registration procedure and a sample registration form, respectively, for a preferred embodiment of the invention.

FIG. 4 is a flowchart diagram illustrating the procedure for accessing the main menu/HTML page after registration for a preferred embodiment of the invention.

FIGS. 5a and 5b show a flowchart diagram illustrating the procedure for posting receivables and corresponding information by a registered user to the database and a sample identification form with the fields that may be used for the posting of a receivable, respectively, for a preferred embodiment of the invention.

FIG. 6 is a flowchart diagram illustrating the procedure for browsing receivables by a registered customer for a preferred embodiment of the invention.

FIG. 7 is a flowchart diagram illustrating the procedure for selecting the form of payment for usage of the website database in a preferred embodiment of the invention.

FIG. 8 is a flowchart for displaying information regarding an available receivable and the option to make an offer for the receivable according to a preferred embodiment of the invention.

FIGS. 9a and 9b are sample illustrations of the receivables information that can be viewed by searchers on the database and a sample offer form, respectively.

FIGS. 10a and 10b are flowcharts illustrating the transaction unit showing an offer to buy and a finalized sale transaction, respectively, according to a preferred embodiment.

### DETAILED DESCRIPTION OF A PREFERRED EMBODIMENT OF THE INVENTION

For the purpose of promoting an understanding of the present invention, reference will be made to multiple embodiments of a business method in which parties wishing to sell one or more receivables are brought in connection with one or more parties wishing to purchase the receivables for the purpose of offsetting payables by buying receivables, preferentially, through the use of a website using Internet communication lines. It will nevertheless be understood that no limitations of the scope of the invention are thereby intended, such as the use of other communication links, changing the information forms displayed in the figures, changing the financial means of payment or exchange of documents, or changing the means by which the parties communicate. It should be noted that the business method with the Internet site can be maintained in-house or by a hosting service employed to provide the hardware and maintain the site. The tools necessary to create the site are already available in the art.

With particular reference to the figures, the reader should know that like numerals in different figures refer to the same elements of the embodiments.

In the following detailed description of the embodiments, “account receivables,” as used herein, is a purchase of goods or services such as by credit card or similar means and represents an open account.

A “note receivable,” as used herein, is defined as a written promise to pay a certain amount of money on a specified future day.

An “obligation,” as used herein, is defined as the debt or action that a corporation, business, or individual(s) must pay or perform. The term “owner,” as used herein, is the person or entity which has a claim to receive a payment (receivable) or an obligation to make a payment (payable), respectively.

“Payable,” as used herein, is defined as an obligation placed upon the payable owner to pay another party for money, goods, or services.

“Receivable,” as used herein, is defined as a claim held against another for money, goods, or services that have not expired. Such claims include trade receivables, account receivables, and note receivables.

“Trade receivables,” as used herein, is defined as an amount of money owed by a customer for goods or services rendered as part of normal business operations.

The following is an illustration of one embodiment of the invention: A purchases goods from B on credit. B has a receivable from A, and A has a payable to B, but A does not pay. C purchases goods from A, such that C has a payable to A, and A has a receivable from C. C purchases B's receivable at a reduced price using the business method discussed herein and uses it to offset its payable to A. B and C both benefit because B receives at least a portion of its receivable and C saves the difference between it's purchase price and the face value of the receivable. This embodiment facilitates C's purchase of B's receivable, preferably, through putting B in contact with C so that B and C can negotiate the sale or through an on-line auction.

In a preferred embodiment of the invention is an on-line sale, conducted in auction format, that allows the owner of a receivable to sell the receivable to the highest bidding third party wishing to use the receivable to offset its own payables and obtain the highest offer for the party selling the receivable. The method, however, in any embodiment, need not be performed on-line.

In an alternative preferred embodiment, the method permits an owner of a receivable, for a fee, to post the receivable and a potential buyer, for a fee, to browse the posted receivables. The method provides a way for a party owning and posting the receivable to include a method of contact within the posting such as an e-mail address, a telephone number, or a mailing address. The means by which the seller of the receivable provides the method of contact is preferentially a field entitled “Method of Contact” that is completed at the same time the other posting information is completed, or other means commonly known in the art. Potential buyer(s) then contact the seller The seller and potential buyer are then free to discuss the conditions for sale of the receivable. Alternatively, the seller of the receivable can choose to not include a method of contact and instead choose to auction the receivable to the highest bidder, as discussed in greater detail herein. The method, however, in any embodiment, need not be performed on-line.

In an alternative embodiment, the method can also be used to provide a method of buying receivables or selling payables in a straight transaction without the requirement of an offsetting obligation. For example, a system user may buy an outstanding receivable for a discounted price hoping to receive a higher payment on the receivable from the original debtor. On the other hand, a user owning a payable may post it in the system in the hopes of fulfilling his obligation at a discount. The payee receiving the discounted payment may then negotiate a still lower payoff of the original payable price or use it as a tax deduction.

In a preferred embodiment, the method for offsetting payables with the sale of receivables is conducted over a computer network system. The central computer is a web site server that is connected to remote computers by telecommunication lines such as Internet lines. The central computer consists of a CPU, a disk, and memory. The central computer can also be connected to a database server, an array of hard disks for storage, load balancing, a fast connector to the Internet, and/or security measures for privacy and to secure financial transactions. Another method of operating this method can be land lines to operators at a central location, satellite transmissions, wireless transmissions, and other methods of communication well known in the art.

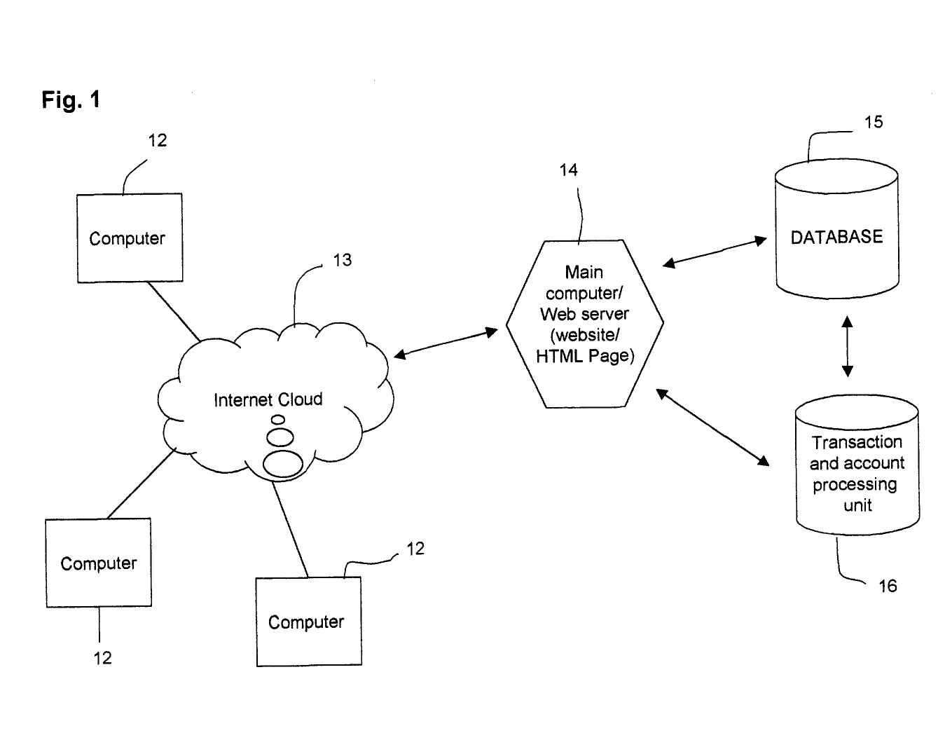

FIG. 1 shows a block diagram illustrating a computer network for a preferred embodiment of the invention. The computer network includes main computer 14, which in the preferred embodiment is a Web server, connected to database 15 which stores the receivable sale information such that database 15 server is accessible to main computer 14. For the purpose of this embodiment, main computer and Web server are interchangeable terms. Web server 14 and database 15 server are also networked to transaction and account processing unit 16 that stores the information regarding registered users and the transactions conducted by the register users. Web server 14 is further networked to a router and modem (not shown) connecting it to Internet 13, allowing a plurality of user computers 12 to connect to Web server 14 via Internet 13. User computers 12 can be sellers, buyers, or browsers. It should be appreciated that additional changes can be made to this embodiment and still maintain the spirit of the embodiment such as the addition of networked database servers, web servers, array(s) of hard disks for storage, and features such as security measures, load balancing, and fast Internet connections.

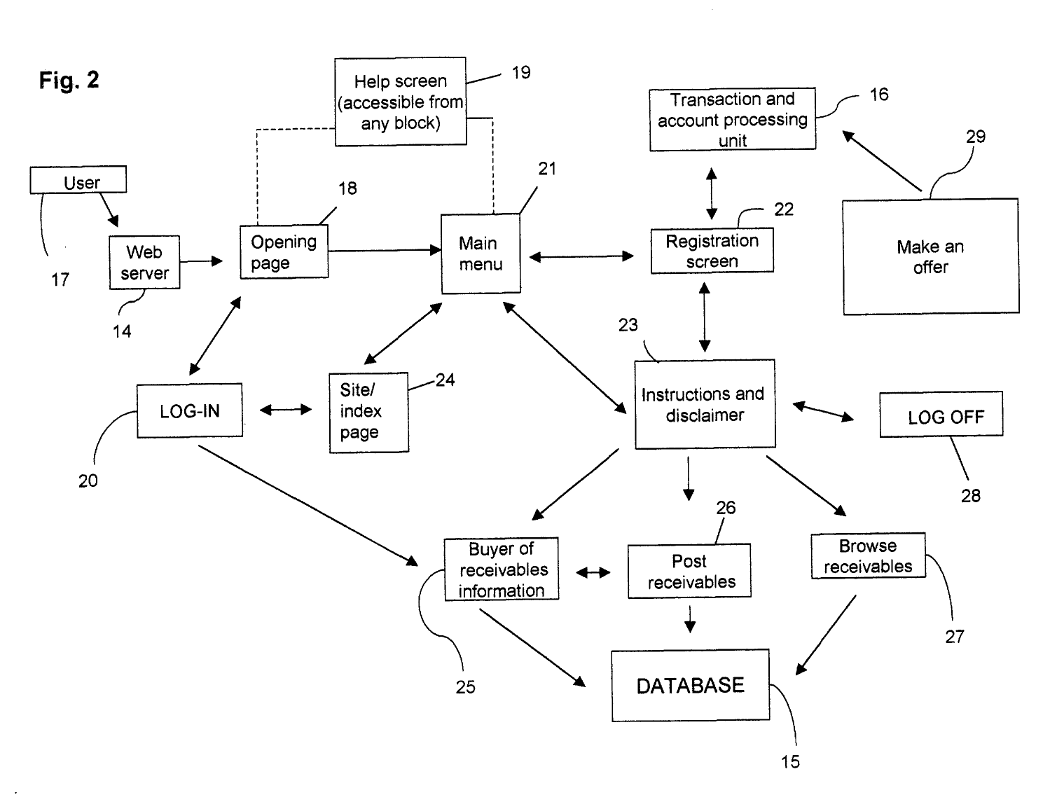

FIG. 2 shows a flowchart illustrating the HTML/website page arrangement for a preferred embodiment of the invention on Web server 14. User 17 connects with web server 14, preferably by using a computer, as shown in FIG. 1. Once connected, opening page 18 or introductory screen is presented containing a brief explanation of the web site. Opening page 18 also provides access to main menu 21 and LOG-IN 20 for previously registered users. Main menu 21 can allow access to certain computer programs, data, and routines via inter-links. Inter-links allow the user to transfer between programs or data. If the user has a member ID, he can proceed directly to any of the programs or databases such as transaction and account processing unit 16 program, database 15, buyer of receivables information 25, post receivables 26, keyword search 84, or the make an offer program 29. If user 17 is not registered, access to main menu 21, site index page 24, instructions and disclaimer 23, and to browse receivables 27 program are through opening page 18. It should be noted that user 17 may be an owner of a receivable and/or a payable or may be a third-party browser who desires to match receivables and payables for his own benefit.

Browse receivables 27 program displays only the names on the receivables posted. If user 17 wants to view more details about the receivable, such as the amount of the receivable or to make an offer for the receivable, it will be necessary to register at registration screen 22 and agree to the user terms agreement. There are several means by which user can browse the posted receivables including a keyword search option that allows user 17 to browse only those receivables containing a specific word or phrase. Instructions and disclaimer site 23 displays information for new users regarding browsing of receivables, posting of receivables, making offers for receivables, information on the transaction process, options for processing transactions, and appropriate disclaimers. Help screen 19 is accessible from any block in the event a question arises during any of the steps of the business method LOG-OFF option 28 is also accessible from any of the blocks.

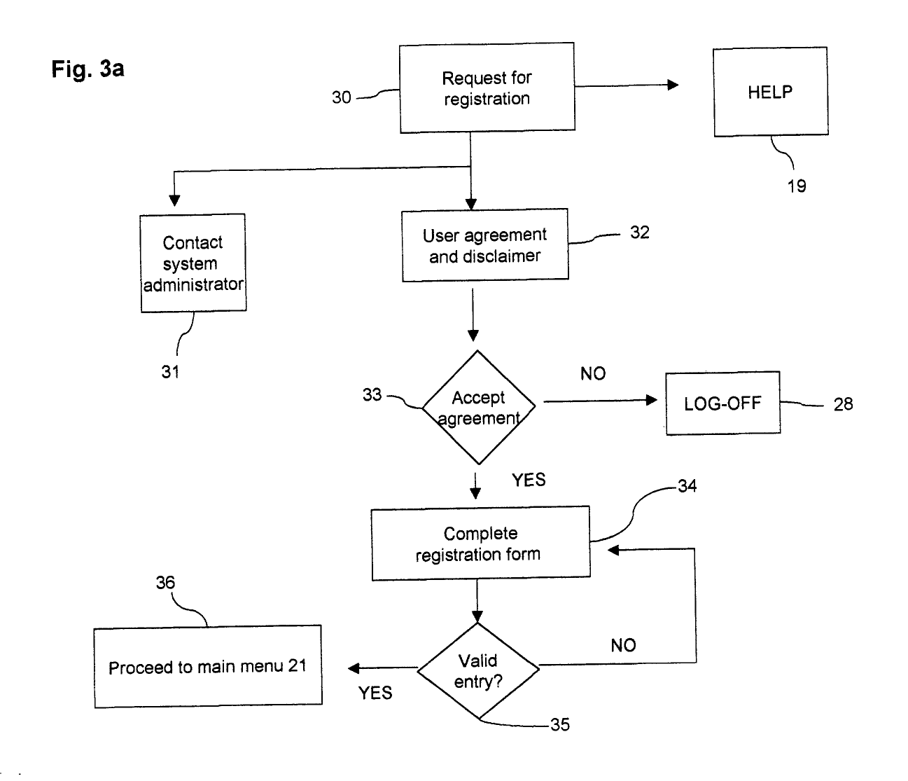

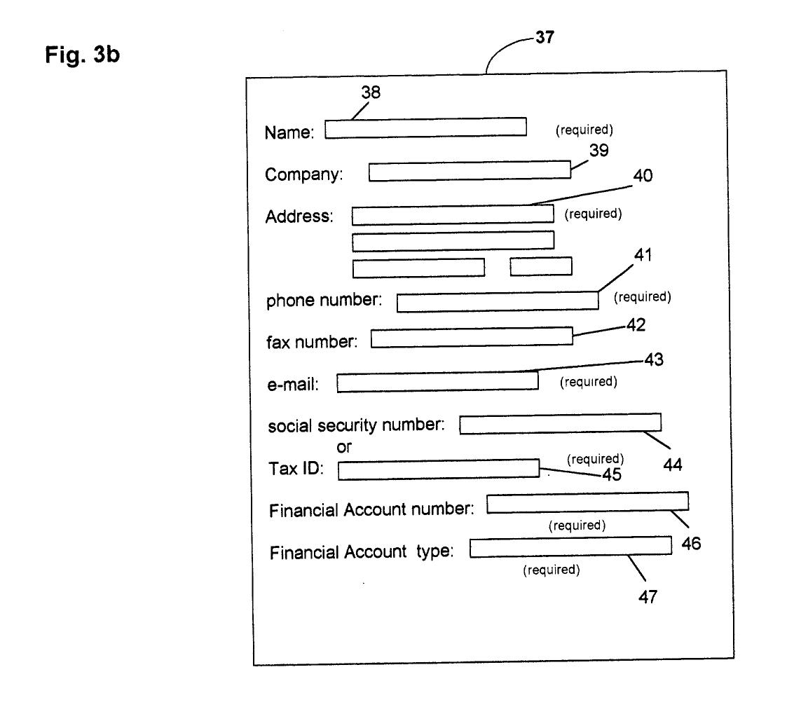

FIGS. 3a and 3b show a flowchart of the registration procedure and a sample registration form 37 according to a preferred embodiment of the invention, respectively. The preferred method includes the step of requiring users to register before posting receivables for sale, browsing information beyond just the name of the posted receivable, or to make an offer to buy a receivable. In the registration process, the central computer creates an account for the user wishing to sell a receivable. Once a request for registration 30 is received, the user next reviews user agreement and disclaimer 32. If any questions arise regarding user agreement and disclaimer 32 or the registration process, there is an option to contact the system administrator 31.

The computer asks whether the user accepts the agreement 33. If the user has not accepted user agreement and disclaimer 32, the user is automatically transferred to LOG-OFF 28 from the site If, however, the user accepts user agreement and disclaimer 32, the next step is completion of registration form 34.

Sample registration form 37 is shown in FIG. 3b. The following is a preferred embodiment of some information that may be collected on each member (but is not limited to):

1. Name 38 of the individual filling in the form;

2. Name of the Business 39 (if not an individual);

3. Address 40;

4. Phone number 41;

5. Fax number 42;

6. E-mail address 43;

7. Social security number 44 or Tax ID 45;

8. Financial account number 46; and

9. Financial account type 47.

In a preferred embodiment, items 1, 3, 4, 6, and 7 are required fields that must be filled before assigning an account and ID number to the user. Social security number 44 or Tax ID number 45 is required even though it will be noted that this information will be utilized only for conducting a credit check. Financial account number 46 is used for the charging of any fees incurred by the user in accordance with the user agreement. This information can be requested at the moment of a service, such as posting, or when a detailed browsing is initiated. Financial account type 47 provides for the explanation of the kind of financial account used (e.g., an escrow service account, a checking account, a savings account, or a credit card number).

Returning to FIG. 3a, the main computer then reviews the information to ensure that all the required fields are completed and include a valid entry 35. If the registration form is successfully completed, the registration will be entered in a registration database, an ID number will be assigned, and the main computer will proceed to main menu 36. In a preferred embodiment, once registration is accepted, the user receives an e-mail message with the account information and a user ID number assigned by the central computer. If the registration is not valid, the computer returns the user to continue completing the registration form 34 indicating which required fields are missing, incomplete, or invalid.

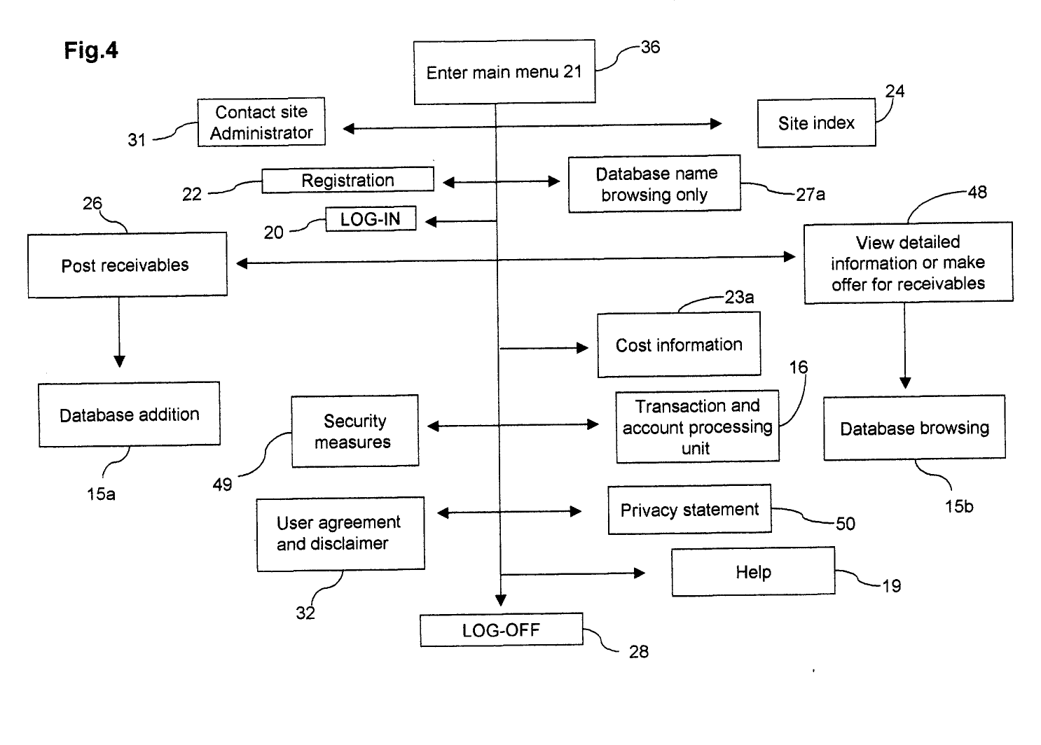

FIG. 4 shows a flowchart diagram illustrating the procedure for accessing the main menu/HTML page after successful registration according to a preferred embodiment. Entering the main menu 36 after registration will display the main group of inter-links or options available to the user. The user can select to go to detailed site index 24 page, which is constructed by expanding each section in the main menu, or a search option for the site and key words. The user also has the option of contacting the site administrator 31 or reading cost information 23a, security measures 49, user agreement and disclaimer 32, and privacy statement 50.

The user can also select the more interactive options such as database name browsing only 27a, registration 22, LOG-IN 20, post receivables 26, or view detailed information or make an offer for receivables 48. If the user chooses to post receivables 26, the computer will advance the user to database addition 15a. If the user chooses to view detailed information or make an offer for a receivable 48, the computer advances the user to database browsing 15b. The user may also view any previous transactions at transaction and account processing unit 16. As always, the user can select the Help option 19 and has the option to LOG-OFF 28.

It should be understood that FIG. 4 is one of many alternative embodiments and modifications that can be constructed within the spirit of the invention such as the addition of other information sites. For example, account information or payment options information can be added to the main menu/html page. It can be appreciated that a registered user can simultaneously post receivables and make offers for other receivables to offset payables. Additionally, an individual or a company can simultaneously have both receivables from one party and payables from others.

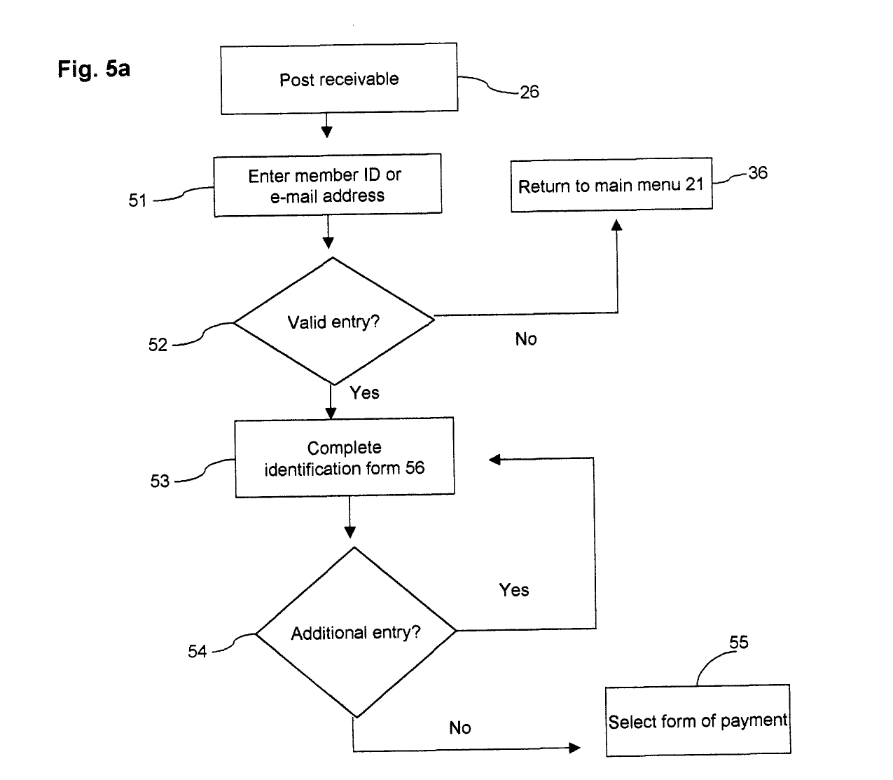

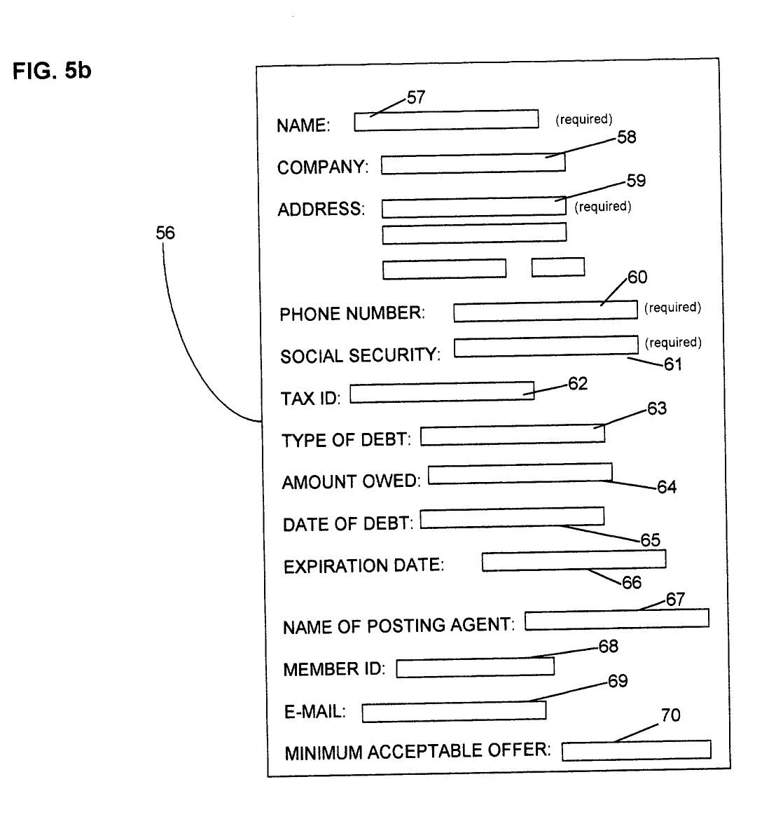

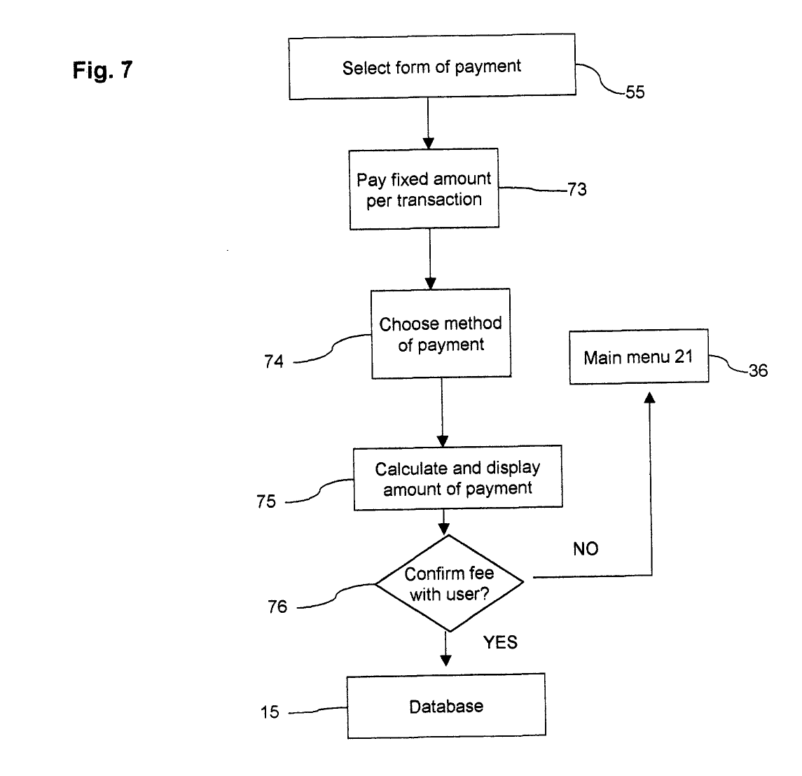

FIG. 5a shows a flowchart diagram illustrating the procedure for posting receivables and corresponding information by a registered user to the database according to a preferred embodiment. The procedure is initiated when a user at the main menu chooses to post one or more receivables 26. The first step in the procedure is a request for the user to enter their member ID or e-mail address 51. The main computer reviews the ID/e-mail information to ensure that the user has made a valid entry 52 and ensures that only registered members access the posting database. If the identification information is invalid or incomplete, the user is returned to main menu 36. If, however, the identification information is valid, the process continues and the computer prompts the user to complete identification form 53. After posting the receivables information, the main computer reviews the information and determines if an additional entry is necessary and asks the user if there is an additional entry to be made 54. If it is necessary for the user to further enter information, or the user desires to post another receivable, the user is returned to complete the identification form. If the identification form has been completed correctly and no more postings are to be completed, the user is prompted to select the form of payment 55 and is linked to the procedure for selection of payment (see FIG. 7). In one embodiment, a flat fee may be required for each individual posting. In an alternate embodiment, a percentage of the sale of the receivable may be paid to the site.

FIG. 5b shows one embodiment of identification form 56 with the fields that may be utilized for the posting of a receivable. Some of the fields in identification form 56 may be required information. For example, in a preferred embodiment, name 57 or company name 58 used on the receivable, address 59, phone number 60, and social security number 61 (if the receivable is against an individual) or tax ID 62 related to the receivable are shown as required fields. Other relevant information may be type of debt 63 (such as trade receivable, credit card balance, etc.), amount owed 64, date of debt 65, and expiration date 66, if any, of the receivable. It may also be necessary to include the name of the posting agent 67 and member ID 68 and/or e-mail address 69. E-mail address 69 and member ID 68 can be used for account identification and validation. It may also be an option to post a minimum acceptable offer 70 to be accepted for the receivable.

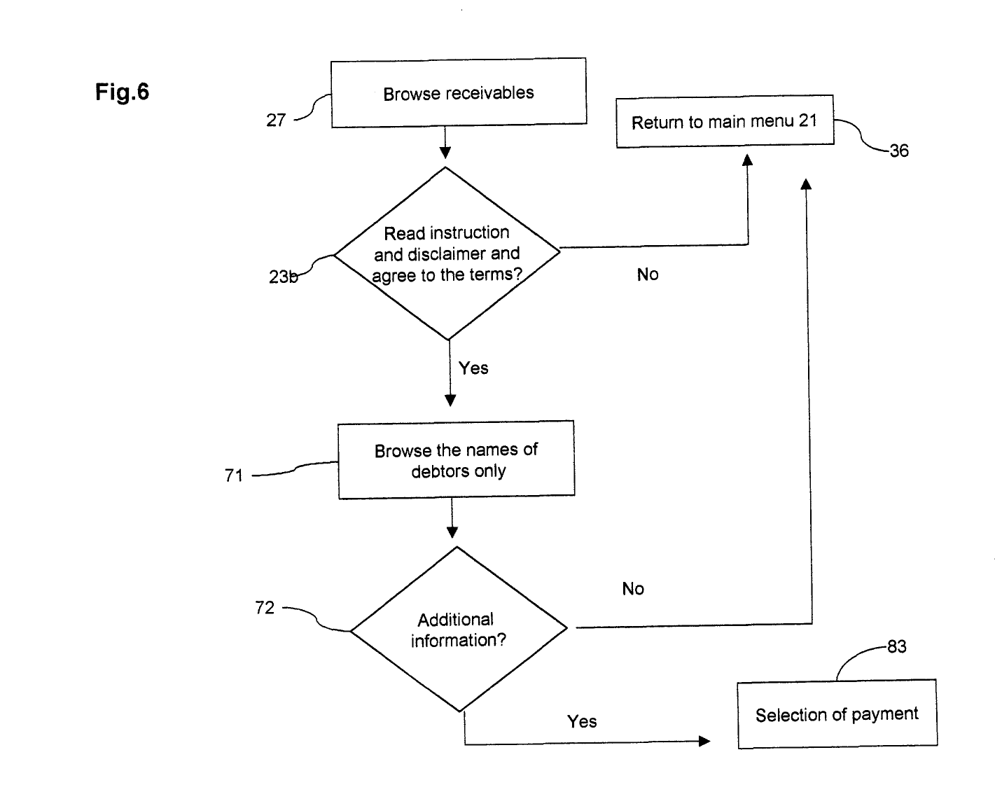

FIG. 6 shows a flowchart diagram illustrating the procedure for browsing receivables 27 by a user according to a preferred embodiment. In a preferred embodiment, a user chooses to enter the receivables database from the main menu. However, a user need not register in order to view only the names of those posting receivables To gain more information, such as confirmation of a name in a receivable through address or Tax ID number, registration is required and the user must read instructions and disclaimer and agree to terms 23b. If the user does not accept the terms, he is returned to the main menu 36. If, however, the user accepts the terms of the disclaimer, the user may choose to browse the names of debtors only 71. In a preferred embodiment, next to each name is a box to check if additional information 72 is desired.

It should be emphasized that more than one type of search methodology can be used. For example, Boolean searches, searches for affiliates, or searches confined to specific industries are well known in the art and can be utilized to aid a user to match receivables and payables owners.

If the user indicates that additional information 72 is required, the next step is selection of payment 83. Payment can be a set fee for each receivable desired to be looked at in detail, a flat fee for viewing the information, a percentage of the final price of the receivable if an offer is accepted, or any combination thereof. If no additional information is desired, the user is returned to the main menu 36.

FIG. 7 shows a flowchart diagram illustrating the procedure for selecting the form of payment 55. Once the user is prompted to begin the payment procedure, it must be determined what the billing choice is. The registered user, whether posting or browsing the information regarding receivables, has different options to pay for the services of the business method presented in this embodiment. As previously mentioned, a fixed amount can be charged for each individual posting or browsing, a percentage of the sale of the receivable sale can be paid to the web site, or a flat fee for unlimited time or for a certain period of time can be arranged. Alternatively, if the receivable is in the form of an electronic document, the financial account of the buyer can automatically be charged after providing notice that the offer has been accepted and the electronic document is exchanged.

FIG. 7 shows an embodiment wherein the user has chosen to pay a fixed amount per transaction 73 for each posting or viewing. The user then chooses the method of payment 74 such as credit card, electronic withdrawal from checking or savings account, or mailing of a check or money order. Once the method of payment is selected, the main computer calculates and displays the amount of payment 75 required, based on the number of postings, the desired number of detailed viewings selected, or the agreed-upon flat fee. After calculating the fee, the computer confirms the fee with the user 76. If the user answers no, the user is directed back to the main menu 36 and no information is displayed or posted. If the user answers affirmatively, the main computer accesses database server 15 and displays the information on the selected receivables.

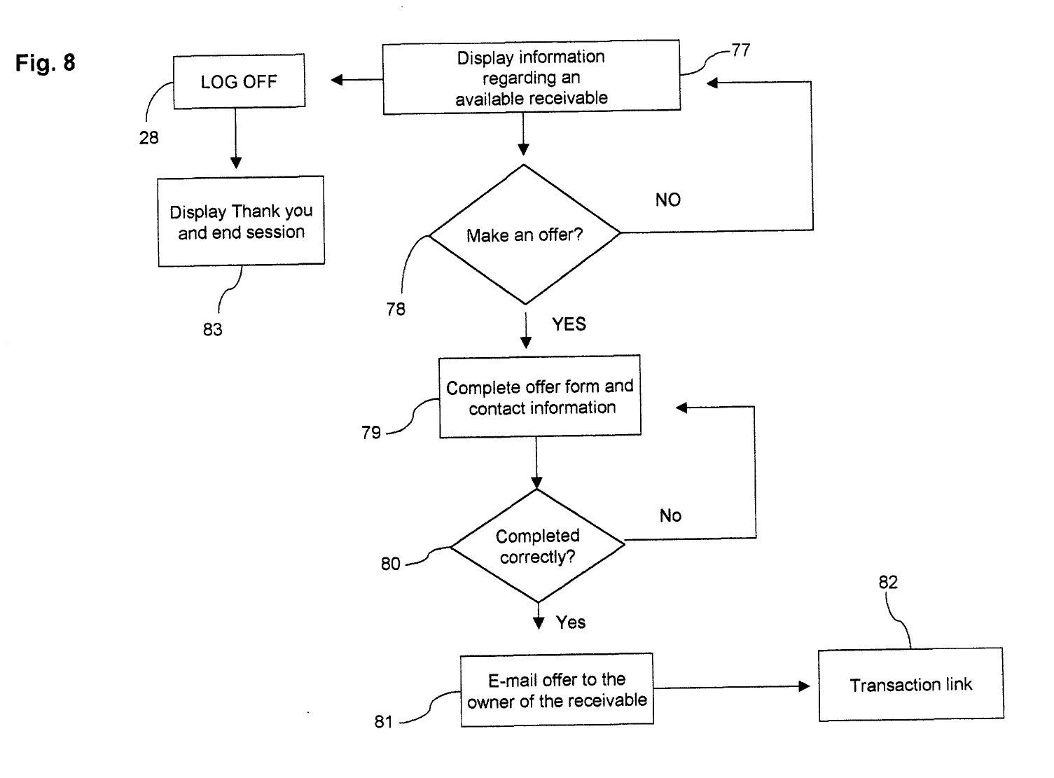

FIG. 8 shows a flowchart for the displaying complete information regarding an available receivable plus the option to make an offer for the receivable according to a preferred embodiment of the invention. The computer displays additional information regarding all available receivables that were checked during browsing. The registered user then has the option to LOG-OFF 28 or to make an offer 78. The user is directed to complete offer form and contact information 79. Once the offer form is completed, the main computer reviews the information to determine if it is completed correctly 80. If correct, the main computer will save it and e-mail the offer to the owner of the receivable 81. If not, the user is directed to complete the offer form and contact information 79 again. In a preferred embodiment, the owner of the receivable is notified of the top five offers. The registered user posting receivables can also review account information of any of the offerors via the transaction link 82 while reviewing the offers.

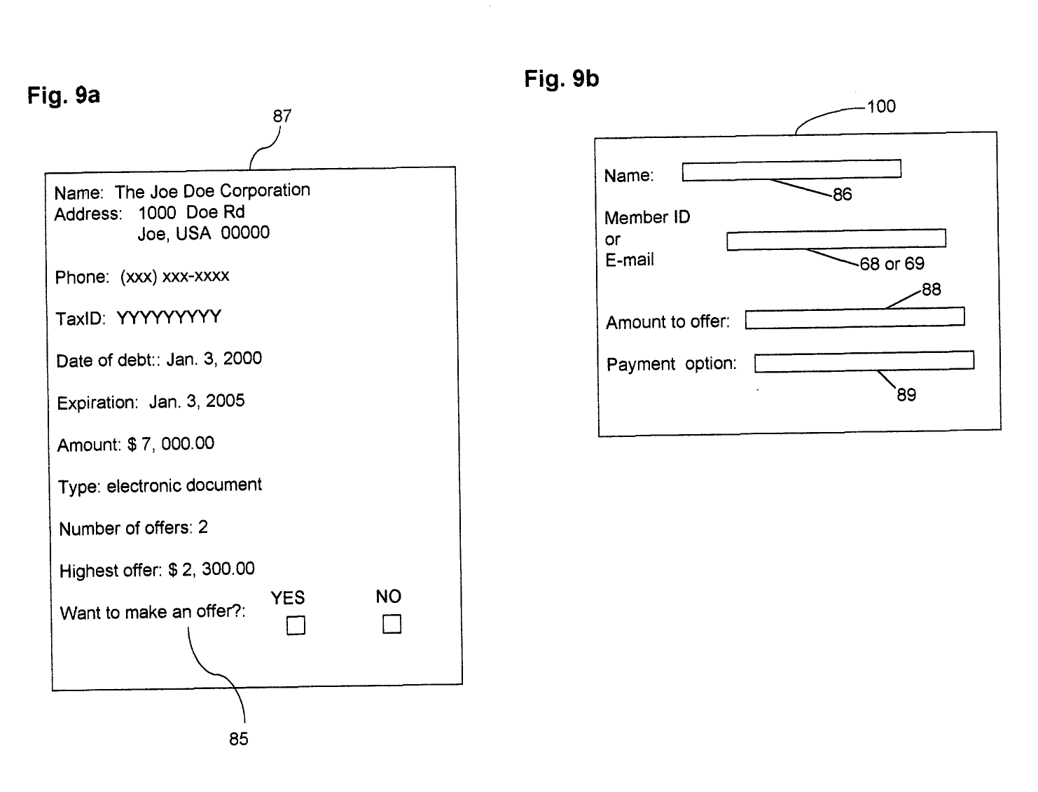

FIG. 9a shows one embodiment of the receivables information that can be viewed by searchers on the database. FIG. 9b shows one embodiment of the offer form. In FIG. 9a, the sample receivable information 87 includes detailed information regarding the receivable. For example name, contact information, date and expiration of the debt, amount of the receivable, the number of offers made, and the highest offer (or, if no offer has yet been made, the lowest offer the seller is willing to accept) are presented to the user. In addition, FIG. 9a shows an interactive step where the browser of the receivable can indicate a desire to make an offer 85. If the answer is yes, the method moves to sample offer form 100. In the embodiment shown in FIG. 9b, the user records his name 86, member ID 68 or e-mail 69, amount of offer 88, and payment option 89 (if different from account member information). As shown in FIG. 8, the main computer checks the information on the offer form to verify that the information is completed correctly 80 and to ensure that the offer is higher than the highest posted offer. Once accepted by the computer, the computer e-mails the offer to the owner of the receivable 81.

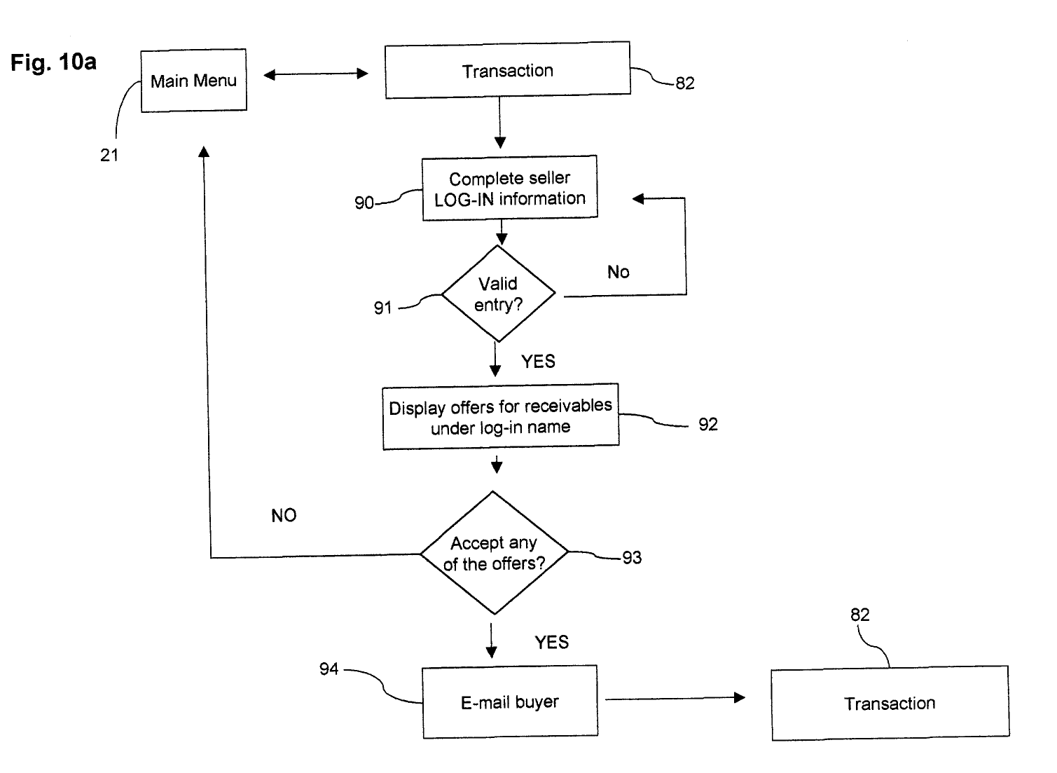

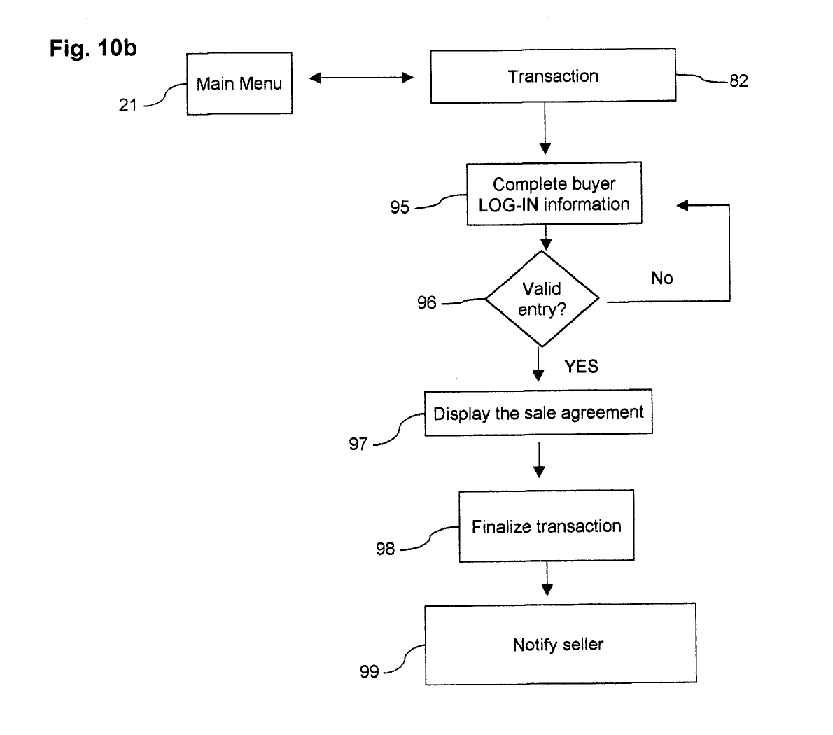

FIGS. 10a and 10b show flowcharts illustrating the transaction unit showing an offer to buy and a finalized sale transaction, respectively, according to a preferred embodiment. The owner of the receivable is informed of the highest offers from each bidding day and can choose to accept an offer or to remain open for additional offers. In a preferred embodiment, the computer contacts the seller via e-mail with the offer and includes a link to transaction program 82. The seller of the receivable enters the transaction site by completing the seller LOG-IN information 90, i.e., member ID number. The main computer checks to make sure the entry is a valid entry 91 and if not, prompts the user to complete the LOG-IN information 90 again. The computer next displays the offers for the receivable under the log-in name 92. The seller is asked whether he/she accepts any of the offers 93. If the answer is yes, the computer e-mails the buyer 94 that made the offer and the seller is returned to the beginning transaction page 82. If the answer is no, other receivables can be checked or the user may go directly to main menu 21 for LOG-OFF.

FIG. 10b shows the final steps on the sale of the receivable. Once the seller accepts an offer and the buyer is contacted, the buyer enters transaction site 82 and completes the buyer log-in information 95. The main computer determines whether the information is a valid entry 96. If the information is invalid, the user is prompted to correct the information by re-completing the log-in information 95. If the information is valid, the computer displays the sale agreement 97 in which the buyer is reminded of the user agreement regarding transactions and responsible parties. After reviewing the sales agreement, the transaction is finalized 98 using the payment option selected by the buyer, and the seller is notified 99 via e-mail to transfer the receivable.

In an alternative embodiment, the users are responsible for the exchange of payment and receivables. However, suggestions posted on the website can help to guide users.

If the buyer of the receivable is also the owner of a payable to the same “other” in the receivable, the buyer can use the receivable to offset the payable. In the case of the seller, when an offer is accepted, the seller is able to increase cash flow and reduce the amount of the receivable that is uncollectible, while maintaining control of the management of the receivables.

What is claimed is:

1. A method for offsetting at least one payable against at least one receivable, wherein said method comprises the steps of:
a) providing a first user access to a central computer;
b) requesting receivable information from said first user;
c) generating a first database of said receivable information;
d) providing a second user with said at least one payable access to said first database;
e) allowing said second user to browse said first database for said at least one receivable to offset said at least one payable; and
f) transmitting an offer to buy said at least one receivable from said second user to said first user through a transaction unit.

2. The method of claim 1, further comprising the step of creating at least one registration account for said first user in said central computer, wherein said at least one registration account includes at least one piece of identification information and a method of payment.

3. The method of claim 2, further comprising the step of creating at least one registration record in a second database accessible to said transaction unit through said central computer, wherein each of said at least one registration records corresponds to one of said at least one registration account.

4. The method of claim 1, further including the step of assigning a first member ID number to said first user.

5. The method of claim 1, further including the step of assigning a second member ID number to said second user.

6. The method of claim 1, further including the steps of:
displaying said receivable information on an online Website;
displaying a disclaimer regarding information posted on said online Website; and
displaying a user agreement to be accepted by said second user before viewing said receivable information.

7. The method of claim 1, further including the step of charging a fee for each of said at least one receivable posted by said first user.

8. The method of claim 1, further including the step of charging a fee for each access to said first database by said second user.

9. The method of claim 2, wherein said method of payment is selected from a group comprising an escrow account, a credit card, and an electronic transfer of funds from a checking account or a savings account.

10. The method of claim 1, wherein said access to said central computer is via at least one method selected from a group comprising phone lines, satellite links, and radio transmissions.

11. The method of claim 1, wherein said allowing said second user to browse said first database for said at least one receivable to offset said at least one payable is completed using a keyword search.
